(19) United States
(12) Patent Application Publication
(10) Pub. No.: US 2026/0128705 A1
(43) Pub. Date: May 7, 2026

(54) Protection Apparatus And Protection Method For Driver, And Driver

(71) Applicant: Siemens Aktiengesellschaft, München (DE)

(72) Inventors: Kai Jiang, Nanjing (CN); Yu Xu, Nanjing (CN)

(73) Assignee: Siemens Aktiengesellschaft, München (DE)

(21) Appl. No.: 19/116,510

(22) PCT Filed: Sep. 30, 2022
(86) PCT No.: PCT/CN2022/123526

§ 371 Date: Mar. 28, 2025

(51) Int. Cl. H02P 29/032

(52) U.S. Cl. CPC H02P 29/032

(57) ABSTRACT

The present disclosure provides protection apparatus and methods for a driver. An example protection apparatus includes a meter, a loop unit, and a controller. The detection unit is configured to detect a current flowing through an inverter unit. The loop unit is configured to connect a positive terminal to a negative terminal of a DC bus or disconnect the positive terminal from the negative terminal of o the DC bus. The control unit is configured to, in response to power on of the driver, control the loop unit to connect the DC bus, and determine, based on a detection result of the detection unit, whether a three-phase AC power is connected to the three-phase motor wiring terminal, wherein in the case that a three-phase AC power is connected to the three-phase motor wiring terminal, the control unit stops.

### CROSS-REFERENCE TO RELATED APPLICATIONS

This application is a U.S. National Stage Application of International Application No. PCT/CN2022/123526 filed Sep. 30, 2022, which designates the United States of America, the contents of which are hereby incorporated by reference in their entirety.

### TECHNICAL FIELD

The present disclosure relates to a protection apparatus. Various embodiments of the teachings herein include protection systems and/or methods for a driver, and/or drivers having a protection apparatus.

### BACKGROUND

A driver acts as a controller to control a motor. A three-phase AC power is typically input to the driver and the driver achieves a three-phase output upon rectification and inversion. The driver is provided with three-phase AC power wiring terminals (L1, L2, and L3) and three-phase motor wiring terminals (U, V, and W). In use, the three-phase AC power is prone to being connected by mistake to the three-phase motor wiring terminals, thereby causing damage to the driver.

### SUMMARY

Teachings of the present disclosure include protection apparatus for a driver, such that the driver is protected in the case that a three-phase AC power is connected by mistake to a three-phase motor wiring terminal. For example, some embodiments include a protection apparatus for a driver, the driver comprising a three-phase AC power wiring terminal, a rectifier unit, a DC bus, an inverter unit, and a three-phase motor wiring terminal that are successively connected, wherein the protection apparatus for the driver comprises: a detection unit (10), configured to detect a current flowing through the inverter unit; a loop unit (20), arranged between a positive terminal and a negative terminal of the DC bus and configured to connect the positive terminal to the negative terminal of the DC bus or disconnect the positive terminal from the negative terminal of the DC bus under control of a drive signal; and a control unit (30), configured to, in response to power on of the driver, control, by generating the drive signal, the loop unit (20) to connect the positive terminal to the negative terminal of the DC bus, and determine, based on a detection result of the detection unit (10), whether a three-phase AC power is connected to the three-phase motor wiring terminal, wherein in a case that a three-phase AC power is connected to the three-phase motor wiring terminal, the control unit (30) stops, in response to receiving a start command, the inverter unit from being started, and in a case that no three-phase AC power is connected to the three-phase motor wiring terminal, the control unit (30) controls, by generating the drive signal, the loop unit (20) to disconnect the positive terminal from the negative terminal of the DC bus, and drives, in response to receiving the start command, the inverter unit to operate.

In some embodiments, the control unit (30) is preassigned with a current threshold greater than or equal to 0 A and is configured to compare the current detected by the detection unit (10) with the current threshold, wherein in a case that the current detected by the detection unit (10) is greater than the current threshold, it is determined that a three-phase AC power is connected to the three-phase motor wiring terminal, and in a case that the current detected by the detection unit (10) is less than or equal to the current threshold, it is determined that no three-phase AC power is connected to the three-phase motor wiring terminal.

In some embodiments, the protection apparatus further comprises an alarm module (40), configured to generate an alarm under control of an alarm signal, wherein the control unit (30) is further configured to control, in response to determining that a three-phase AC power is connected to the three-phase motor wiring terminal, the alarm module (40) to generate the alarm by generating the alarm signal.

In some embodiments, the detection unit (10) comprises: a sampling resistor module (12), arranged between the DC bus and the inverter unit, wherein the sampling resistor module (12) is connected to the control unit (30).

In some embodiments, the detection unit (10) further comprises: an analog-to-digital converter module (14), connected to the sampling resistor module (12) and the control unit (30), wherein the analog-to-digital converter module (14) is configured to perform analog-to-digital conversion on the current detected by the sampling resistor module (12) and send the analog-to-digital converted current to the control unit (30).

In some embodiments, the loop unit (20) comprises: an insulated gate bipolar transistor (22) and a consuming resistor (24), wherein the insulated gate bipolar transistor (22) and the consuming resistor (24) are connected in series between the positive terminal and the negative terminal of the DC bus, and the drive signal is a PWM signal output by the control unit (30) to a gate electrode of the insulated gate bipolar transistor (22).

In some embodiments, the driver further comprises a brake unit, wherein the loop unit (20) is the brake unit of the driver.

As another example, some embodiments include a driver comprising: three three-phase AC power wiring terminals (51), connected to a three-phase AC power; a rectifier unit (52), connected to the three three-phase AC power wiring terminals (51) and configured to convert a three-phase AC power to a DC power; a DC bus, connected to the rectifier unit (52) and configured to receive a DC power; an inverter unit (54), connected to the DC bus and configured to convert a DC power to a three-phase AC power for controlling a motor; three three-phase motor wiring terminals (55), connected to a three-phase motor; and a protection apparatus as described herein, wherein the detection unit (10) is configured to detect a current flowing through the inverter unit (54), the loop unit (20) is arranged between a positive terminal and a negative terminal of the DC bus and is configured to connect the positive terminal to the negative terminal of the DC bus or disconnect the positive terminal from the negative terminal of the DC bus under control of a drive signal, and the control unit (30) is configured to, in response to power on of the driver, control, based on the drive signal, the loop unit (20) to connect the positive terminal to the negative terminal of the DC bus, and determine, based on a detection result of the detection unit (10), whether a three-phase AC power is connected to the three-phase motor wiring terminal (55), wherein in a case that a three-phase AC power is connected to the three-phase motor wiring terminal (55), the control unit (30) stops, in response to receiving a start command, the inverter unit (54) from being started, and in a case that no three-phase AC power is connected to the three-phase motor wiring terminal (55), the control unit (30) controls, based on the drive signal, the loop unit (20) disconnect the positive terminal from the negative terminal of the DC bus, and drives, in response to receiving the start command, the inverter unit (54) to operate.

As another example, some embodiments include a protection method for a driver, the driver comprising a three-phase AC power wiring terminal, a rectifier unit, a DC bus, an inverter unit, and a three-phase motor wiring terminal that are successively connected, wherein the protection method for the driver comprises: connecting a positive terminal to a negative terminal of the DC bus in response to power on of the driver; detecting a current flowing through the inverter unit, and determining the current as a detected current; determining, based on the detected current, whether a three-phase AC power is connected to the three-phase motor wiring terminal; stopping, in response to receiving a start command, the inverter unit from being started, in a case that a three-phase AC power is connected to the three-phase motor wiring terminal; and disconnecting the positive terminal from the negative terminal of the DC bus and driving, in response to receiving the start command, the inverter unit to operate, in a case that no three-phase AC power is connected to the three-phase motor wiring terminal.

In some embodiments, in determining, based on the detected current, whether a three-phase AC power is connected to the three-phase motor wiring terminal, the detected current is compared with a current threshold greater than or equal to 0 A, wherein in a case that the detected current is greater than the current threshold, it is determined that a three-phase AC power is connected to the three-phase motor wiring terminal, and in a case that the detected current is less than or equal to the current threshold, it is determined that no three-phase AC power is connected to the three-phase motor wiring terminal.

### BRIEF DESCRIPTION OF THE DRAWINGS

The accompanying drawings are merely for schematic and illustrative description and demonstration of the present disclosure, instead of limiting the scope of the present disclosure. In the figures:

FIG. 1 is a schematic structural diagram of an example protection apparatus for a driver incorporating teachings of the present

FIG. 2 is a schematic structural diagram of an example protection apparatus for a driver incorporating teachings of the present disclosure; and

FIG. 3 is a schematic flowchart of an example protection method for a driver incorporating teachings of the present disclosure.

### REFERENCE NUMERALS AND DENOTATIONS THEREOF

10-Detection unit
12-Sampling resistor module
14-Analog-to-digital converter module
20-Loop unit
22-Insulated gate bipolar transistor
24-Consuming resistor
30-Control unit
40-Alarm module
51-Three-phase AC power wiring terminal
52-Rectifier unit
54-Inverter unit
55-Three-phase motor wiring terminal
60-Motor

### DETAILED DESCRIPTION

Teachings of the present disclosure include drivers protected using the protection apparatus described herein in the case that a three-phase AC power is connected by mistake to a three-phase motor wiring terminal. Some embodiments include a protection method for a driver, such that the driver is protected in the case that a three-phase AC power is connected by mistake to a three-phase motor wiring terminal.

The driver includes a three-phase AC power wiring terminal, a rectifier unit, a DC bus, an inverter unit, and a three-phase motor wiring terminal that are successively connected. In some embodiments, a protection apparatus for the driver includes a detection unit, a loop unit, and a control unit. The detection unit is configured to detect a current flowing through the inverter unit. The loop unit is arranged between a positive terminal and a negative terminal of the DC bus and is configured to connect the positive terminal to the negative terminal of the DC bus or disconnect the positive terminal from the negative terminal of the DC bus under control of a drive signal. The control unit is configured to, in response to power on of the driver, control, by generating the drive signal, the loop unit to connect the positive terminal to the negative terminal of the DC bus, and determine, based on a detection result of the detection unit, whether a three-phase AC power is connected to the three-phase motor wiring terminal. In the case that a three-phase AC power is connected to the three-phase motor wiring terminal, the control unit stops, in response to receiving a start command, the inverter unit from being started. In the case that no three-phase AC power is connected to the three-phase motor wiring terminal, the control unit controls, by generating the drive signal, the loop unit to disconnect the positive terminal from the negative terminal of the DC bus, and drives, in response to receiving the start command, the inverter unit to operate.

The protection apparatus for the driver may include the detection unit, the loop unit, and the control unit. The control unit controls the loop unit to connect the positive terminal to the negative terminal of the DC bus in the case that the driver is connected, and the detection unit detects whether a current flows through the inverter unit, such that whether a three-phase AC power is connected by mistake to the three-phase motor wiring terminal is determined. The control unit controls, based on a determination result, whether to start the inverter unit of the driver, such that the driver is protected.

In some embodiments, the control unit is preassigned with a current threshold greater than or equal to 0 A and is configured to compare the current detected by the detection unit with the current threshold. In the case that the current detected by the detection unit is greater than the current threshold, it is determined that a three-phase AC power is connected to the three-phase motor wiring terminal. In the case that the current detected by the detection unit is less than or equal to the current threshold, it is determined that no three-phase AC power is connected to the three-phase motor wiring terminal. In this way, accuracy of the determination is improved.

In some embodiments, the protection apparatus further includes an alarm module, configured to generate an alarm under control of an alarm signal. The control unit is further configured to control, in response to determining that a three-phase AC power is connected to the three-phase motor wiring terminal, the alarm module to generate the alarm by generating the alarm signal. In this way, a user is timely reminded that a three-phase AC power is connected to the three-phase motor wiring terminal.

In some embodiments, the detection unit includes a sampling resistor module, arranged between the DC bus and the inverter unit. The sampling resistor module is connected to the control unit.

In some embodiments, the detection unit further includes an analog-to-digital converter module, connected to the sampling resistor module and the control unit. The analog-to-digital converter module is configured to perform analog-to-digital conversion on the current detected by the sampling resistor module and send the analog-to-digital converted current to the control unit. In this way, the detection unit is applicable to the control unit having no analog-to-digital conversion function.

In some embodiments, the loop unit includes an insulated gate bipolar transistor and a consuming resistor. The insulated gate bipolar transistor and the consuming resistor are connected in series between the positive terminal and the negative terminal of the DC bus, and the drive signal is a PWM signal output by the control unit to a gate electrode of the insulated gate bipolar transistor.

In some embodiments, the driver further includes a brake unit. The loop unit is the brake unit of the driver.

In some embodiments, a driver includes three three-phase AC power wiring terminals, a rectifier unit, a DC bus, an inverter unit, three three-phase motor wiring terminals, and a protection apparatus as described above. The three three-phase AC power wiring terminals are connected to a three-phase AC power. The rectifier unit is connected to the three three-phase AC power wiring terminals and is configured to convert a three-phase AC power to a DC power. The DC bus is connected to the rectifier unit and is configured to receive a DC power. The inverter unit is connected to the DC bus and is configured to convert a DC power to a three-phase AC power for controlling a motor. The three three-phase motor wiring terminals are connected to a three-phase motor. The detection unit is configured to detect a current flowing through the inverter unit, the loop unit is arranged between a positive terminal and a negative terminal of the DC bus and is configured to connect the positive terminal to the negative terminal of the DC bus or disconnect the positive terminal from the negative terminal of the DC bus under control of a drive signal, and the control unit is configured to, in response to power on of the driver, control, based on the drive signal, the loop unit to connect the positive terminal to the negative terminal of the DC bus, and determine, based on a detection result of the detection unit, whether a three-phase AC power is connected to the three-phase motor wiring terminal. In the case that a three-phase AC power is connected to the three-phase motor wiring terminal, the control unit stops, in response to receiving a start command, the inverter unit from being started. In the case that no three-phase AC power is connected to the three-phase motor wiring terminal, the control unit controls, based on the drive signal, the loop unit to disconnect the positive terminal from the negative terminal of the DC bus, and drives, in response to receiving the start command, the inverter unit to operate.

In some embodiments, there is a protection method for a driver. The driver includes a three-phase AC power wiring terminal, a rectifier unit, a DC bus, an inverter unit, and a three-phase motor wiring terminal that are successively connected. The protection method for the driver includes: connecting a positive terminal to a negative terminal of the DC bus in response to power on of the driver; detecting a current flowing through the inverter unit, and determining the current as a detected current; determining, based on the detected current, whether a three-phase AC power is connected to the three-phase motor wiring terminal; stopping, in response to receiving a start command, the inverter unit from being started, in the case that a three-phase AC power is connected to the three-phase motor wiring terminal; and disconnecting the positive terminal from the negative terminal of the DC bus and driving, in response to receiving the start command, the inverter unit to operate, in the case that no three-phase AC power is connected to the three-phase motor wiring terminal.

In some embodiments, in determining, based on the detected current, whether a three-phase AC power is connected to the three-phase motor wiring terminal, the detected current is compared with a current threshold greater than or equal to 0 A. In the case that the detected current is greater than or equal to the current threshold, it is determined that a three-phase AC power is connected to the three-phase motor wiring terminal. In the case that the detected current is less than or equal to the current threshold, it is determined that no three-phase AC power is connected to the three-phase motor wiring terminal.

For clearer descriptions of the technical features, objects, and the technical effects of the present disclosure, the specific embodiments of the present disclosure are hereinafter described with reference to the accompanying drawings. In the drawings, like reference numerals denote elements having the same structure or having the similar structure but the same function. In this text, the term “exemplary” or “schematic” is used herein to mean “serving as an example, instance, or illustration,” and any illustration or embodiment described herein as “exemplary” shall not be necessarily construed as preferred or advantageous over other illustrations or embodiments.

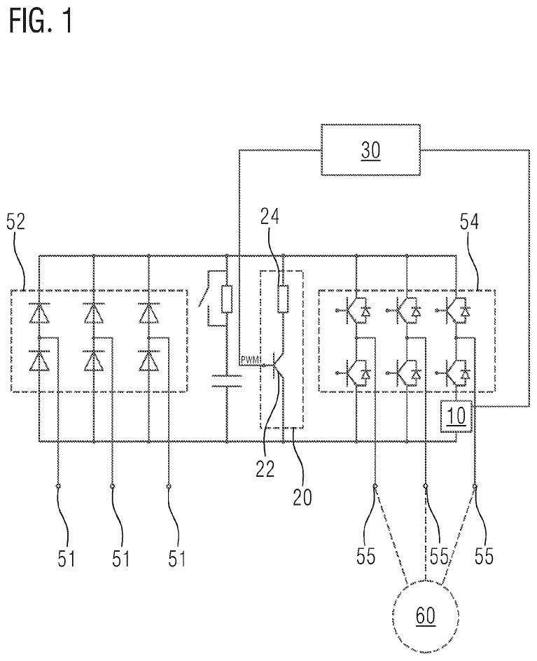

FIG. 1 is a schematic structural diagram of an example protection apparatus for a driver incorporating teachings of the present disclosure. Referring to FIG. 1, the driver includes three-phase AC power wiring terminals, a rectifier unit 52, a DC bus, an inverter unit 54, and three-phase motor wiring terminals 55 that are successively connected. The protection apparatus for the driver includes a detection unit 10, a loop unit 20, and a control unit 30.

The detection unit 10 is configured to detect a current flowing through the inverter unit 54. In one or more exemplary embodiments, the detection unit 10 includes a sampling resistor module 12, arranged between the DC bus, and one of three phases of the inverter unit 54. In one or more exemplary embodiments, the detection unit 10 may also be another element having a current measurement function, and the detection unit 10 may also be arranged between the inverter 54 and one of the three-phase motor wiring terminals 55.

The loop unit 20 is arranged between a positive terminal and a negative terminal of the DC bus and is configured to connect the positive terminal to the negative terminal of the DC bus or disconnect the positive terminal from the negative terminal of the DC bus under control of a drive signal. In one or more exemplary embodiments, the loop unit 20 includes an insulated gate bipolar transistor 22 and a consuming resistor 24, wherein the insulated gate bipolar transistor 22 and the consuming resistor 24 are connected in series between the positive terminal and the negative terminal of the DC bus. The drive signal is a PWM signal output by the control unit 30 to a gate electrode of the insulated gate bipolar transistor 22. The consuming resistor 24 is configured to consume power energy in the circuit in the case that the positive terminal is connected to the negative terminal of the DC bus to prevent short circuit of the DC bus.

The control unit 30 is configured to, in response to power on of the driver, control, by generating the drive signal, the loop unit 20 to connect the positive terminal to the negative terminal of the DC bus, and determine, based on a detection result of the detection unit 10, whether a three-phase AC power is connected to the three-phase motor wiring terminal 55. In the case that a three-phase AC power is connected to the three-phase motor wiring terminal 55, the control unit 30 stops, in response to receiving a start command, the inverter unit 54 from being started. In the case that no three-phase AC power is connected to the three-phase motor wiring terminal 55, the control unit 30 controls, by generating the drive signal, the loop unit 20 to disconnect the positive terminal from the negative terminal of the DC bus, and drives, in response receiving to the start command, the inverter unit 54 to operate.

In actual use of the protection apparatus, in the case that the driver is connected, the control unit 30 first controls the insulated gate bipolar transistor 22 to be turned on; and in the case that a three-phase AC power is connected to the three-phase motor wiring terminal 55, the inverter unit 54 forms a three-phase rectifier bridge circuit that rectifies the three-phase AC power to a DC power and outputs the DC power to the DC bus. The DC power upon rectification forms a loop on the DC bus by virtue of the loop unit 20. In this case, the detection unit 10 is capable of detecting that a current flows through the inverter unit 54. The control unit 30 is preassigned with a current threshold greater than or equal to 0 A. The control unit 30 is configured to compare the current detected by the detection unit 10 with the current threshold. In the case that the current detected by the detection unit 10 is greater than the current threshold, it is determined that a three-phase AC power is connected to the three-phase motor wiring terminal 55, and the control unit 30 stops, in response to receiving a start command, the inverter unit 54 from being started, such that short circuit of the three-phase AC power is prevented and the driver is protected from damages.

On the contrary, in the case that the three-phase AC power is correctly connected to the three-phase AC power wiring terminal 51, even though the insulated gate bipolar transistor 22 is connected, no current flows through the inverter unit 54 before the inverter unit 54 is started. In this case, the detection unit 10 fails to measure a current. The control unit 30 is configured to determine, in response to the current detected by the detection unit 10 being less than or equal to the current threshold, that no three-phase AC power is connected to the three-phase motor wiring terminal 55. The control unit 30 controls, by generating the drive signal, the loop unit 20 to disconnect the positive terminal from the negative terminal of the DC bus, and drives, in response to receiving the start command, the inverter unit 54 to operate.

The control unit 30 is preassigned with a current threshold for preventing circuit interference in the driver. A specific value of the current, threshold may be defined according to actual application scenarios.

In some embodiments, the protection apparatus for the driver includes the detection unit 10, the loop unit 20, and the control unit 30. The control unit 30 controls the loop unit 20 to connect the positive terminal to the negative terminal of the DC bus in the case that the driver is connected, and the detection unit 10 detects whether a current flows through the inverter unit 54, such that whether a three-phase AC power is connected by mistake to the three-phase motor wiring terminal is determined. The control unit 30 controls, based on a determination result, whether to start the inverter unit 54 of the driver, such that the driver is protected.

In some embodiments, the driver further includes a brake unit. The brake unit generally includes a brake resistor and an insulated gate bipolar transistor. During electric braking, the motor 60 operates in a power generation mode, a generated three-phase AC power returns to the DC bus via the inverter unit 54, such that a voltage on the DC bus is increased. In the case that it is detected that the DC voltage exceeds a predefined value, the insulated gate bipolar transistor is turned on, such that excessive power energy on the DC bus is consumed by the brake resistor in terms of heat generation. In some embodiments, the loop unit 20 is a brake unit of the driver, the insulated gate bipolar transistor 22 is an insulated gate bipolar transistor of the brake unit, and the consuming resistor 24 is a brake resistor of the brake unit. In this way, the same member achieves two functions, such that manufacture costs are lowered.

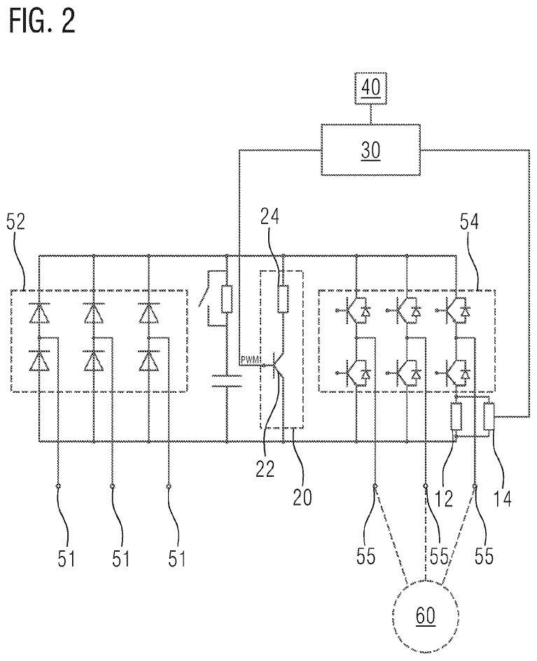

FIG. 2 is a schematic structural diagram of an example protection apparatus for a driver incorporating teachings of the present disclosure. Referring to FIG. 2, identical or similar parts over those in FIG. 1 are not described herein any further. The difference over FIG. 1 lies in that the protection apparatus further includes an alarm module 40. The alarm module 40 is capable of generating an alarm under control of an alarm signal, for example, emitting light or generating sound. The control unit 30 is further configured to control, in response to determining that a three-phase AC power is connected to the three-phase motor wiring terminal 55, the alarm module 40 generate the alarm by generating the alarm signal. In this way, a user is timely reminded to correct errors.

In some embodiments, referring to FIG. 2, the detection unit 10 further includes an analog-to-digital converter module 14, connected to the sampling resistor module 12 and the control unit 30, wherein the analog-to-digital converter module 14 is configured to perform analog-to-digital conversion on the current detected by the sampling resistor module 12 and send the analog-to-digital converted current to the control unit 30. In this way, the detection unit is applicable to the control unit having no analog-to-digital conversion function.

In some embodiments, a driver includes three three-phase AC power wiring terminals 51, a rectifier unit 52, a DC bus, an inverter unit 54, three three-phase motor wiring terminals 55, and a protection apparatus as described herein. The three three-phase AC power wiring terminals 51 are connected to a three-phase AC power. The rectifier unit 52 is connected to the three three-phase AC power wiring terminals 51 and is configured to convert a three-phase AC power to a DC power. The DC bus is connected to the rectifier unit 52 and is configured to receive a DC power. The inverter unit 54 is connected to the DC bus and is configured to convert a DC power to a three-phase AC power for controlling a motor 60. The three three-phase motor wiring terminals 55 are connected to the motor 60. The detection unit 10 is configured to detect a current flowing through the inverter unit, the loop unit 20 is arranged between a positive terminal and a negative terminal of the DC bus and is configured to connect the positive terminal to the negative terminal of the DC bus or disconnect the positive terminal from the negative terminal of the DC bus under control of a drive signal, and the control unit 30 is configured to, in response to power on of the driver, control, based on the drive signal, the loop unit 20 to connect the positive terminal to the negative terminal of the DC bus, and determine, based on a detection result of the detection unit 10, whether a three-phase AC power is connected to the three-phase motor wiring terminal 55. In the case that a three-phase AC power is connected to the three-phase motor wiring terminal 55, the control unit 30 stops, in response to receiving a start command, the inverter unit 54 from being started. In the case that no three-phase AC power is connected to the three-phase motor wiring terminal 55, the control unit 30 controls, based on the drive signal, the loop unit 20 to disconnect the positive terminal from the negative terminal of the DC bus, and drives, in response to receiving the start command, the inverter unit 54 to operate.

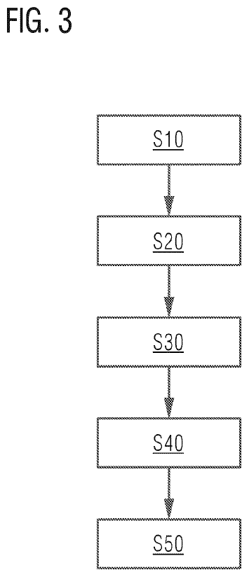

In some embodiments, there is a protection method for a driver. The driver includes a three-phase AC power wiring terminal 51, a rectifier unit 52, a DC bus, an inverter unit 54, and a three-phase motor wiring terminal 55 that are successively connected. FIG. 3 is a schematic flowchart of an example protection method for a driver incorporating teachings of the present disclosure. Referring to FIG. 3, the protection method for the driver includes:

In step S10, a positive terminal is connected to a negative terminal of the DC bus in response to power on of the driver.

In step S20, a current flowing through the inverter unit 54 is detected, and is determined as a detected current;

In step S30, whether a three-phase AC power is connected to the three-phase motor wiring terminal 55 is determined based on the detected current. Specifically, the detected current is compared with a current threshold greater than or equal to 0 A. In the case that the detected current is greater than or equal to the current threshold, it is determined that a three-phase AC power is connected to the three-phase motor wiring terminal 55. In the case that the detected current is less than or equal to the current threshold, it is determined that no three-phase AC power is connected to the three-phase motor wiring terminal 55.

In step S40, in the case that a three-phase AC power is connected to the three-phase motor wiring terminal, in response to receiving a start command, the inverter unit 54 is stopped from being started.

In step S50, in the case that no three-phase AC power is connected to the three-phase motor wiring terminal, the positive terminal is disconnected from the negative terminal of the DC bus, and the inverter unit 54 is driven, in response to receiving the start command, to operate.

It should be understood that, although this specification is described based on the embodiments, not each of the embodiments discloses an independent technical solution. Such description manner of the specification is only for clarity. A person skilled in the art should consider the specification as an entirety. The technical solutions according to the embodiments may also be suitably combined to derive other embodiments that may be understood by a person skilled in the art.

A series of detailed descriptions given in this specification are merely intended to illustrate feasible embodiments of the present disclosure, instead of limiting the protection scope of the present disclosure. Any equivalent embodiments or modifications, for example, combinations, segmentations, or repetition of features, derived without departing from the spirit of the present disclosure shall fall within the protection scope of the present disclosure.

What is claimed is:

1. A protection apparatus for a driver, the driver comprising a three-phase AC power wiring terminal, a rectifier unit, a DC bus, an inverter unit, and a three-phase motor wiring terminal that are successively connected, the protection apparatus comprising:
a meter to detect a current flowing through the inverter unit;
a loop arranged between a positive terminal and a negative terminal of the DC bus and operable to connect and disconnect the positive terminal to the negative terminal of the DC bus under control of a drive signal; and
a controller to generate the drive signal in response to power on of the driver, driving the loop unit to connect the positive terminal to the negative terminal of the DC bus, and to determine, based on a detection result of the meter, whether a three-phase AC power is connected to the three-phase motor wiring terminal;
wherein in a case that a three-phase AC power is connected to the three-phase motor wiring terminal, the controller stops the inverter unit from being started in response to receiving a start command, and in a case that no three-phase AC power is connected to the three-phase motor wiring terminal, the controller generate the drive signal to drive the loop unit to disconnect the positive terminal from the negative terminal of the DC bus, and drives, in response to receiving the start command, the inverter unit to operate.

2. The protection apparatus according to claim 1, wherein:
the control unit is preassigned with a current threshold greater than or equal to 0 A and is configured to compare the current detected by the meter with the current threshold;
in a case that the current detected by the meter is greater than the current threshold, assess a three-phase AC power is connected to the three-phase motor wiring terminal, and in a case that the current detected by the meter is less than or equal to the current threshold, no three-phase AC power is connected to the three-phase motor wiring terminal.

3. The protection apparatus according to claim 1, further comprising an alarm module to generate an alarm under control of an alarm signal;
wherein the controller controls the alarm module to generate the alarm by generating the alarm signal in response to determining that a three-phase AC power is connected to the three-phase motor wiring terminal.

4. The protection apparatus according to claim 1, wherein:
the meter comprises: a sampling resistor module arranged between the DC bus and the inverter unit; and
sampling resistor module is connected to the controller.

5. The protection apparatus according to claim 4, wherein:
the meter further comprises an analog-to-digital converter module connected to the sampling resistor module and the controller;
the analog-to-digital converter module is configured to perform analog-to-digital conversion on the current detected by the sampling resistor module and send the analog-to-digital converted current to the controller.

6. The protection apparatus according to claim 1, wherein:
the loop unit comprises: an insulated gate bipolar transistor and a consuming resistor connected in series between the positive terminal and the negative terminal of the DC bus; and
the drive signal comprises a PWM signal output by the controller to a gate electrode of the insulated gate bipolar transistor.

7. The protection apparatus according to claim 1, wherein:
the driver further comprises a brake unit; and
the loop unit comprises the brake unit of the driver.

8. A driver comprising:
three three-phase AC power wiring terminals connected to a three-phase AC power;
a rectifier unit connected to the three three-phase AC power wiring terminals and configured to convert a three-phase AC power to a DC power;
a DC bus connected to the rectifier unit and configured to receive a DC power;
an inverter unit, connected to the DC bus and configured to convert a DC power to a three-phase AC power for controlling a motor;
three three-phase motor wiring terminals, connected to a three-phase motor; and
a protection apparatus including:
a meter to detect a current flowing through the inverter unit;
a loop unit arranged between a positive terminal and a negative terminal of the DC bus and operable to connect and disconnect the positive terminal to the negative terminal of the DC bus under control of a drive signal; and
a controller to generate the drive signal in response to power on of the driver, driving the loop unit to connect the positive terminal to the negative terminal of the DC bus, and to determine, based on a detection result of the meter, whether a three-phase AC power is connected to the three-phase motor wiring terminal;
wherein the meter is configured to detect a current flowing through the inverter unit, the loop unit is arranged between a positive terminal and a negative terminal of the DC bus and is configured to connect the positive terminal to the negative terminal of the DC bus or disconnect the positive terminal from the negative terminal of the DC bus under control of a drive signal, and the controller, is configured to, in response to power on of the driver, control, based on the drive signal, the loop unit to connect the positive terminal to the negative terminal of the DC bus, and determine, based on a detection result of the meter, whether a three-phase AC power is connected to the three-phase motor wiring terminal, wherein in a case that a three-phase AC power is connected to the three-phase motor wiring terminal (55), the controller stops, in response to receiving a start command, the inverter unit from being started, and in a case that no three-phase AC power is connected to the three-phase motor wiring terminal, the controller controls, based on the drive signal, the loop unit to disconnect the positive terminal from the negative terminal of the DC bus, and drives, in response to receiving the start command, the inverter unit to operate.

9. A protection method for a driver, the driver comprising a three-phase AC power wiring terminal, a rectifier unit, a DC bus, an inverter unit, and a three-phase motor wiring terminal that are successively connected, the protection method comprising:
connecting a positive terminal to a negative terminal of the DC bus in response to power on of the driver;
detecting a current flowing through the inverter unit, and determining the current as a detected current;
determining whether a three-phase AC power is connected to the three-phase motor wiring terminal based on the detected current;
stopping the inverter unit from being started, in a case that a three-phase AC power is connected to the three-phase motor wiring terminal in response to receiving a start command; and
disconnecting the positive terminal from the negative terminal of the DC bus and driving the inverter unit to operate in response to receiving the start command, and in a case that no three-phase AC power is connected to the three-phase motor wiring terminal.

10. The protection method according to claim 9, wherein:
determining, whether a three-phase AC power is connected to the three-phase motor wiring terminal based on the detected current includes comparing, the detected current to a current threshold greater than or equal to 0 A
in a case that the detected current is greater than the current threshold, determining that a three-phase AC power is connected to the three-phase motor wiring terminal, and
in a case that the detected current is less than or equal to the current threshold, determining that no three-phase AC power is connected to the three-phase motor wiring terminal.
